(19) United States
(12) Patent Application Publication
(10) Pub. No.: US 2020/0364220 A1
(43) Pub. Date: Nov. 19, 2020

(54) OBJECT-BASED QUERY LANGUAGE CONVERSION AND ENRICHMENT FOR DATABASE QUERIES

(71) Applicant: SAP SE, Walldorf (DE)

(72) Inventors: Karthik Kamath, Bangalore (IN); Rick Banerjee, Bangalore (IN)

(73) Assignee: SAP SE, Walldorf (DE)

(21) Appl. No.: 16/413,482

(22) Filed: May 15, 2019

(51) Int. Cl. G06F 16/2452; G06F 16/25

(52) U.S. Cl. CPC G06F 16/2452; G06F 16/258

(57) ABSTRACT

Technologies are described for converting object-based query language queries into structured query language (SQL) queries. For example, converting an object-based query written in an object-based query language to generate a converted SQL query can comprise extracting incompatible keywords from the object-based query, generating metadata for objects and fields used in the object-based query, inserting implicit query information into the object-based query, and transforming a structure of the object-based query into a SQL compatible structure. The object-based query can also be enriched with application information for mapping entities to specific applications. The converted SQL query can be output.

### BACKGROUND

Typical enterprise-level software systems may consist of several monolithic legacy applications designed to serve specific business objectives. With monolithic legacy applications, data is centrally stored in a data store, which is typically a relational database. There is usually a complex domain object model which defines the entities used by the system. These entities are stored and retrieved from the data store using a proprietary object-based query language, which can appear similar to structured query language (SQL), but is not SQL compatible.

As the monolithic legacy applications age, they can become cumbersome and inefficient. In order to increase the efficiency and usability of the services provided by the monolithic legacy applications, certain components can be broken out and redesigned (e.g., using new technologies and development techniques).

While separating out new services from the monolithic legacy applications can increase efficiency and usability, there are a number of problems with this approach. For example, each of the new services typically manages its own data store, which can use different storage technology (e.g., a different type of database or data store) than that used by the monolithic legacy applications. The new services may also utilize different technologies (e.g., different interfaces or query languages) to access the stored data. Furthermore, the object-based query language that was utilized by the monolithic legacy applications may not work with the new services. For example, the new services may be designed to work with standard SQL queries. As a result, working in an environment that uses both monolithic legacy applications and new services can be difficult.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various technologies are described herein for converting object-based query language queries into structured query language (SQL) queries. For example, converting an object-based query written in an object-based query language to generate a converted SQL query can comprise extracting incompatible keywords from the object-based query, generating metadata for objects and fields used in the object-based query, inserting implicit query information into the object-based query, and transforming a structure of the object-based query into a SQL compatible structure. The converted SQL query can be output. In some implementations, the object-based query is enriched with application information for mapping entities to specific applications.

### BRIEF DESCRIPTION OF THE DRAWINGS

FIG. 1 is a diagram depicting an example monolithic legacy application environment that includes a relational database.

FIG. 2 is a diagram depicting a distributed query engine environment for accessing micro services and legacy applications.

FIG. 3 is a diagram depicting an example environment for converting object-based query language queries into structured query language (SQL) queries.

FIG. 4A depicts an example object-based query.

FIG. 4B depicts an example object-based query after incompatible keywords have been extracted.

FIG. 4C depicts example metadata generated for an example object-based query.

FIG. 4D depicts an example object-based query after implicit query information has been inserted.

FIG. 4E depicts an example object-based query that has been converted into a SQL compatible structure.

FIG. 4F depicts an example converted SQL query that has been converted from an example object-based query. The converted SQL query has been enriched with application information for mapping entities to specific applications (e.g., which may be needed so that a distributed query engine can select the right connectors to execute the query and retrieve the data from the correct application or applications).

FIG. 5 is a diagram depicting example operations that can be performed by an example distributed query engine.

FIG. 6 is a diagram depicting an example object-based query conversion environment.

FIG. 7 is a flowchart of an example method for converting object-based query language queries into SQL queries.

FIG. 8 is a flowchart of an example method for converting object-based query language queries into SQL queries. The converted SQL queries can be enriched with application information for mapping entities to specific applications (e.g., which may be needed so that a distributed query engine can select the right connectors to execute the queries and retrieve the data from the correct application or applications).

FIG. 9 is a diagram of an example computing system in which some described embodiments can be implemented.

FIG. 10 is an example cloud computing environment that can be used in conjunction with the technologies described herein.

### DETAILED DESCRIPTION

Overview

The following description is directed to technologies for converting object-based query language queries into structured query language (SQL) queries. For example, converting an object-based query written in an object-based query language to generate a converted SQL query can comprise extracting incompatible keywords from the object-based query, generating metadata for objects and fields used in the object-based query, inserting implicit query information into the object-based query, and transforming a structure of the object-based query into a SQL compatible structure. The converted SQL query can be output. In some implementations, the object-based query is enriched with application information for mapping entities to specific applications.

### Monolithic Legacy Application Environment

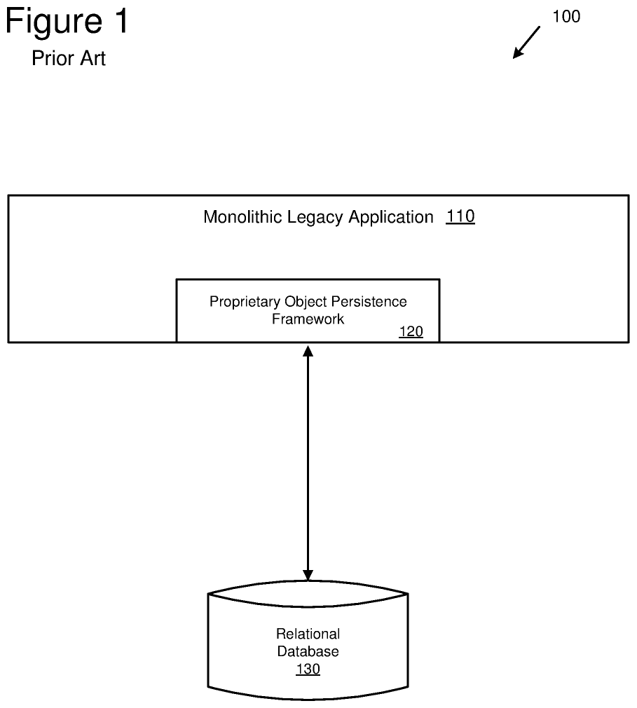

FIG. 1 is a diagram depicting an example prior art monolithic legacy application environment 100 that includes a relational database. The environment 100 includes a monolithic legacy application 110. For example, the monolithic legacy application 110 can be operated as a software-as-a-service (SaaS). The monolithic legacy application 110 can support a specific business objective (or objectives). For example, the monolithic legacy application 110 can serve a particular domain (e.g., a business domain, such as a procurement domain).

The monolithic legacy application 110 stores its data in a central data store, which in this case is a relational database 130. The monolithic legacy application 110 works with entities (also referred to as objects) defined by a domain object model when storing and retrieving data from the data store. For example, the domain object model can define entities such as requisitions, invoices, receipts, contracts, and so on. The entities defined by the domain object model can be related to the specific domain that the monolithic legacy application 110 services (e.g., the procurement domain or another domain).

The monolithic legacy application 110 accesses the entities in the relational database 130 via a proprietary object persistence framework 120 that uses an object-based query language. The object-based query language is in some ways similar to SQL, but it is not compatible with SQL. Unlike a SQL query, which is written in terms of tables and columns, an object-based query language is written in terms of classes (object-oriented classes) and fields. An object-based query language can provide advantages over SQL. For example, an object-based query language can provide an abstraction in which objects are used to access database data (which can still be stored in tables), but with added efficiency provided by the object abstraction (e.g., an object could provide a more efficient way to access data in multiple tables without the complexity of querying the multiple tables individually). Another advantage is that an object-based query language supports inheritance. For example, querying on a given object can automatically query on objects that inherit from the given object (e.g., a single query statement can be used to query on the given object as well as all of the child objects of the given object). Object-based querying using inheritance can therefore inherently perform joins and aggregation in an abstracted manner.

An object-based query language can be designed to closely model one or more specific domains (e.g., specific domains served by the monolithic legacy application 110). For example, the classes referenced to by an object-based query language can be the classes that belong to the domain entities (domain model entities). The domain entities can be organized into an entity hierarchy. For example, a procurement domain can have child entities such as requisitions, invoices, etc. Each entity can have fields (e.g., an invoice entity could have an invoice number field, an invoice amount field, etc.). An object-based query could can access the various entities and fields of the domain.

### Environment Supporting Micro Services and Legacy Applications

As monolithic legacy applications (e.g., monolithic legacy application 110) age, there is a need to redesign specific components to meet new business requirements and scale the applications to serve increasing customer demands. In a typical scenario, functions (e.g., business and/or technical functions) that need new capabilities are identified. These identified functions are then extracted out of the monolithic legacy application and re-created as one or more micro services, with each of the micro services storing data in its own data store. The micro services can be built with the latest technology and can be designed to scale horizontally.

However, by creating micro services with their own data stores, problems can be introduced into the environment because data is no longer centrally stored. For example, each of the micro services can have their own data stores (e.g., relational databases, document stores, key value stores, etc.) that are separate from data store used by the legacy application. A typical solution to address this problem is to deploy a distributed query engine. The distributed query engine has connectors that can query data from multiple sources and combine the data (e.g., perform aggregations). However, the distributed query engine cannot parse and execute queries written in an object-based query language (e.g., a proprietary object-based query language). Therefore, a distributed query engine may not be able to operate (or may have limited functionality) in an environment that uses an object-based query language (e.g., one that supports monolithic legacy applications).

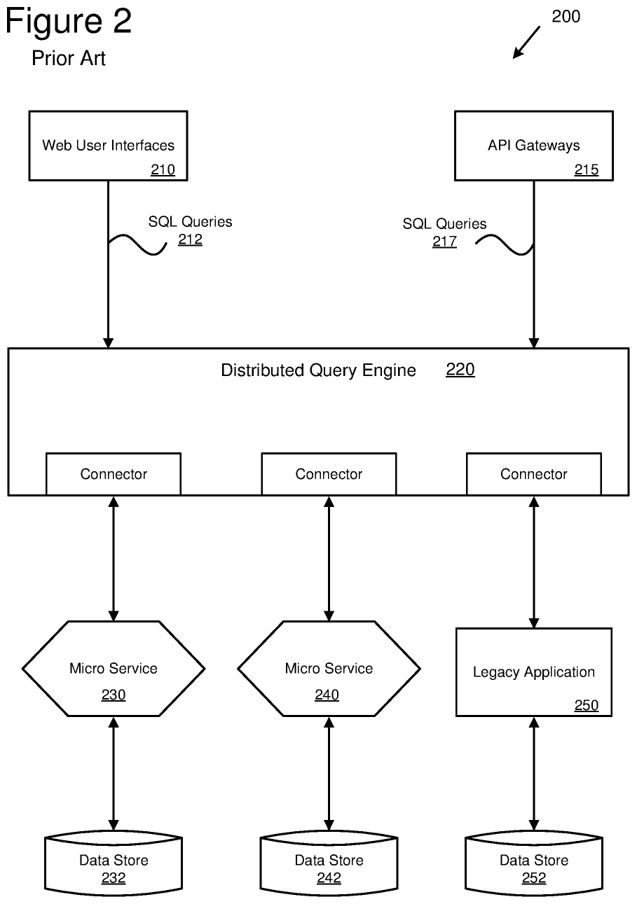

FIG. 2 is a diagram depicting a prior art distributed query engine environment 200 for accessing micro services and legacy applications. The environment 200 includes distributed query engine 220 that supports querying data from multiple different services. One example of a distributed query engine is the Presto distributed query engine provided by the Presto Software Foundation. In the example environment 200, the distributed query engine 220 accesses data from a number of micro services, including micro service 230 and 240. Micro service 230 stores its data in data store 232 and micro service 240 stores its data in data store 242. The distributed query engine 220 also accesses data from legacy application 250, which stores its data in data store 252. The distributed query engine 220 uses connectors to access the micro services and legacy applications. For example, the connectors can be specific to the micro service or legacy application and provide application programming interfaces (APIs) to access the data stored by the micro services and legacy applications. In the example environment 200, micro services 230 and 240 were previously part of legacy application 250, but have been extracted out into their own services each with their own data stores. While the example environment 200 depicts two micro services and one legacy application, in general the distributed query engine 220 can support a different number of micro services and/or legacy applications.

The distributed query engine 220 receives SQL queries which the distributed query engine 220 in turn executes via one or more of the connected micro services (e.g., micro services 230 and 240) and legacy applications (e.g., legacy application 250). The SQL queries can be received by the distributed query engine 220 via web user interfaces 210, as indicated by SQL queries 212, via API gateways 215, as indicated by SQL queries 217, and/or from other sources.

While the distributed query engine 220 provides an improved environment that allows some interoperability with micro services and legacy applications, the distributed query engine 220 still suffers some significant limitations. For example, the distributed query engine 220 can only understand SQL queries and therefore cannot parse and execute object-based queries written in an object-based query language.

### Environments for Converting Object-Based Queries into SQL Queries

In the technologies described herein, environments are provided for converting object-based queries into SQL queries. For example, an object-based query can be received (e.g., by a query conversion engine). The object-based query (e.g., in a proprietary object-based query language) can be converted into a SQL query that is in a SQL compatible format. In some implementations, the SQL compatible format is a format that is compatible with the American National Standards Institute (ANSI) SQL standard. In some implementations the SQL compatible format is ANSI SQL compatible with the addition of application connector prefixes.

Conversion of the object-based query can comprise one or more of the following operations: extracting incompatible keywords from the object-based query, generating metadata for objects and fields used in the object-based query, inserting implicit query information into the object-based query, transforming a structure of the object-based query into a SQL compatible structure, and enriched the object-based query with application information for mapping entities to specific applications (e.g., which may be needed so that the a distributed query engine can select the right connectors to execute the query and retrieve the data from the correct application or applications). The converted SQL query can be output. For example, the converted SQL query can be executed by a distributed query engine and/or other SQL query processing functionality.

Converting object-based queries into SQL queries provides a number of advantages. For example, some environments (e.g., legacy database environments, such as monolithic legacy applications) only support queries written in an object-based query language while other environments (e.g., newer database environments) only support queries written in a SQL compatible format. In order to run queries that access data within both types of environments, different types of queries may have to be generated and the results combined, which can be a time consuming and inefficient process (e.g., in terms of computing resources, such as processor utilization, memory utilization, and network resources). By converting object-based queries into SQL queries, queries that cover data in both environments can be generated and run, which is more efficient in terms of time and computing resources. For example, a service, such as a distributed query engine or other type of query processing resource, can receive SQL queries and run the SQL queries against different applications or data sources (e.g., across micro services, legacy applications, and/or other types of applications).

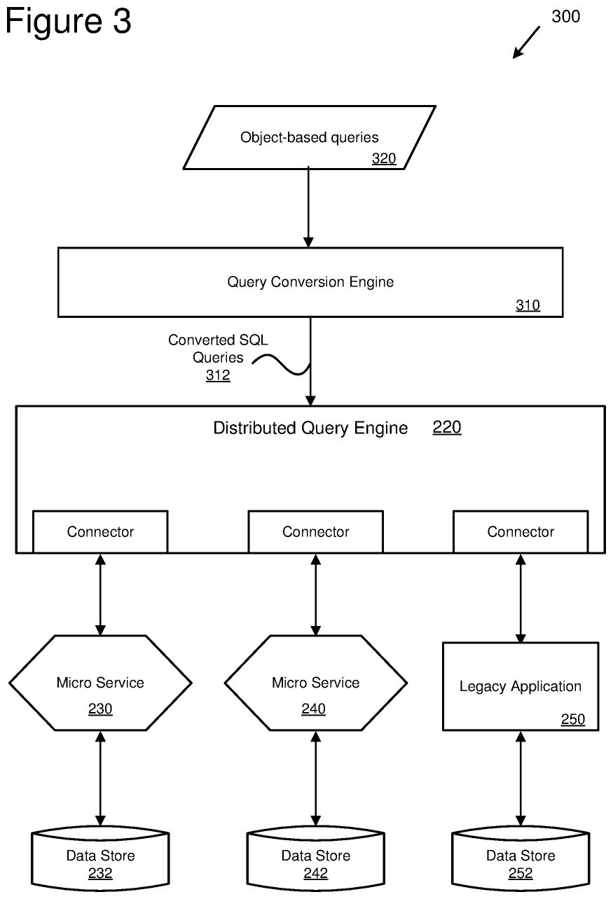

FIG. 3 is a diagram depicting an example environment 300 for converting object-based queries into SQL queries for use by a distributed query engine. In the example environment 300, object-based queries 320 are received by a query conversion engine 310. For example, the object-based queries 320 can be received from user interfaces (e.g., via web user interfaces), from API gateways, from client applications, and/or from other sources. The query conversion engine 310 performs operations for converting the received object-based queries 320 into converted SQL queries 312. For example, the query conversion engine 310 can perform one or more of the following operations: extract incompatible keywords from the object-based query, generate metadata for objects and fields used in the object-based query, insert implicit query information into the object-based query, transform a structure of the object-based query into a SQL compatible structure, and enrich the object-based query with application information for mapping entities to specific applications (e.g., which may be needed so that the a distributed query engine can select the right connectors to execute the query and retrieve the data from the correct application or applications). The query conversion engine can output the converted SQL queries 312. For example, the converted SQL queries 312 can be provided to the distributed query engine 220 for execution. For example, the distributed query engine 220 can use application information (e.g., provided within, or in addition to, the converted SQL queries 312) to select the right connectors when executing the converted SQL queries 312. The converted SQL queries 312 can also be output to other systems (e.g. to other query processing engines) in addition to, or instead of, to the distributed query engine 220. The query conversion engine 310 can be implemented by different types of hardware resources (e.g., server computers, desktop computers, database systems, and/or other types of computing devices) and/or software resources.

### Converting Object-Based Queries into SQL Queries

In the technologies described herein, object-based queries (e.g., queries in a proprietary object-based query language) can be converted into SQL queries (e.g., queries that are SQL compatible). Conversion of object-based queries into SQL queries can involve a number of operations, which can comprise: extracting incompatible keywords from the object-based query, generating metadata for objects and fields used in the object-based query, inserting implicit query information into the object-based query, transforming a structure of the object-based query into a SQL compatible structure, and/or enriched the object-based query with application information for mapping entities to specific applications.

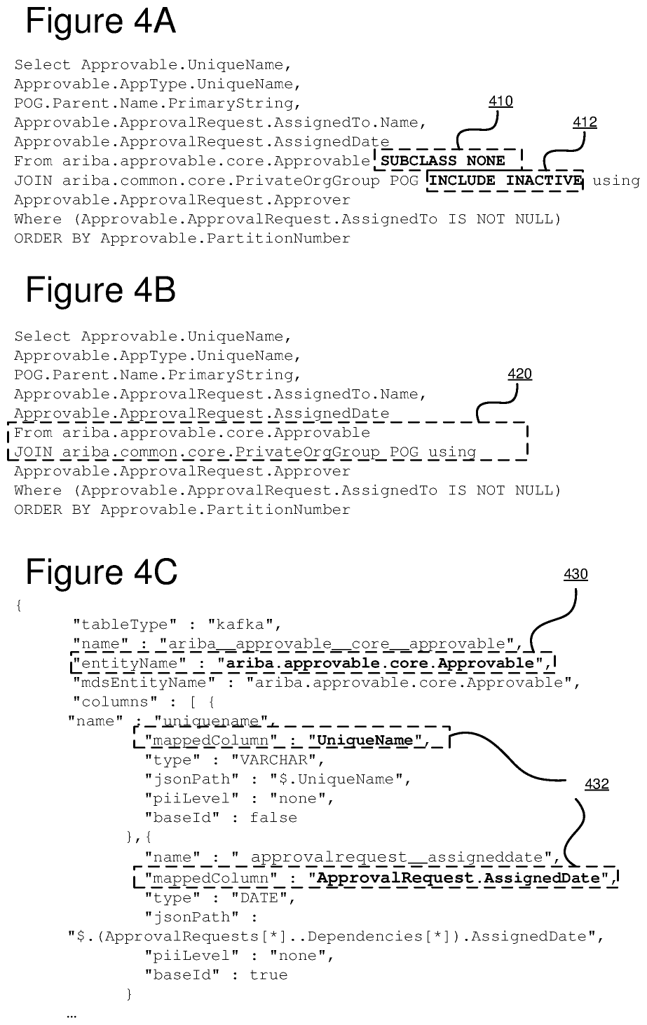

FIG. 4A depicts an example object-based query. The example object-based query is for selecting approvable items (e.g., line items, requisitions, purchase orders, etc.) in a procurement system. The example object-based query is written in an object-based query language that is not SQL compatible. For example, the object-based query includes keywords 410 and 412 that are specific to the object-based query language. Specifically, the “SUBCLASS NONE” keyword 410 prevents the example object-based query from accessing subclasses of the Approvable class so that only fields at the Approvable object level are queried (e.g., if Purchase Order is a subclass of the Approvable class, then Purchase Order subclass objects will not be queried), and the “INCLUDE INACTIVE” keyword 420 means that the query will also include deactivated objects. These example keywords 410 and 420 are domain specific and are not SQL compatible. In addition, the example object-based query uses an object-oriented dot notation to access classes and subclasses (e.g., an entity hierarchy). For example, “Approvable.ApprovalRequest.AssignedTo.Name” references a hierarchy of objects.

In some implementations, object-based queries can be run in a multi-tenant environment. Each tenant can use a different type of enterprise resource planning (ERP) system, and each type of ERP system may use a different variant of the domain object model (e.g., have different classes, class names, field names, etc.). For example, “Approvable.ApprovalRequest.AssignedDate” in one ERP system could be “Approvable.ApprovalRequest.DatOfAssignment” in another ERP system. During conversion of an object-based query, such variant details can be taken into account.

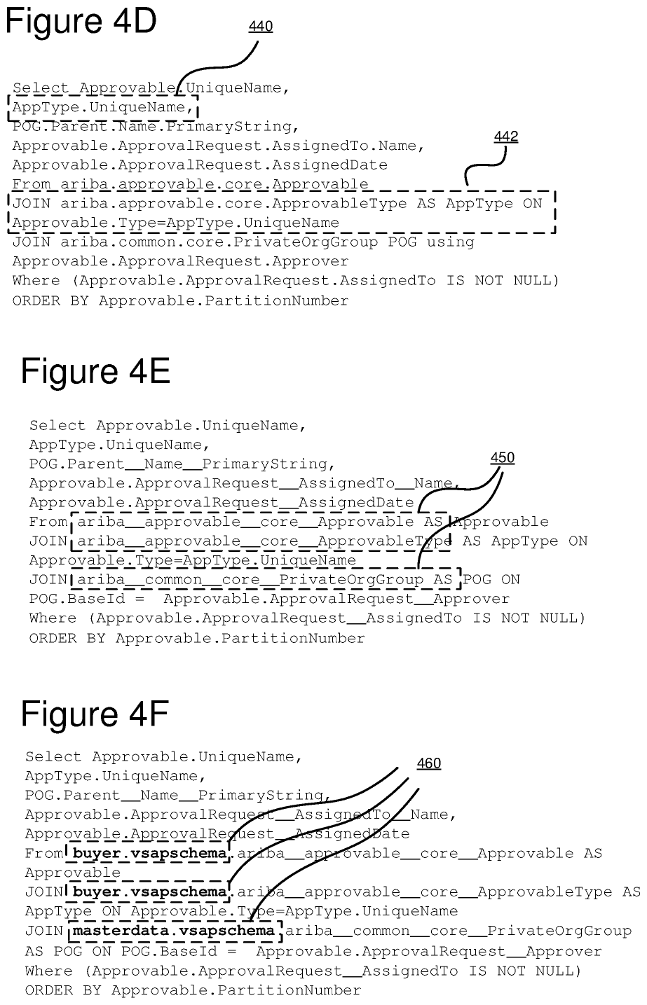

FIG. 5 is a diagram depicting an example query conversion engine 310, including example operations that can be performed by the query conversion engine 310 in order to convert object-based queries into converted SQL queries. The depicted operations could also be performed by another type of system (e.g., hardware and/or software) other than a query conversion engine. As depicted at 505, the query conversion engine 310 receives an object-based query (e.g., an object-based query in a proprietary object-based query language). As depicted at 510, incompatible keywords are extracted from the object-based query. In some implementations, the incompatible keywords are non-SQL keywords (e.g., keywords that are not compatible with SQL, such as keywords that are not defined by the ANSI SQL standard). The extracted incompatible keywords can be saved for later use (e.g., output along with the converted SQL query and used when the converted SQL query is executed).

As depicted at 520, metadata is generated for fields used by the object-based query. For example, metadata can be generated to map the objects (entities) and fields used in the object-based query to their associated database tables and fields.

As depicted at 530, implicit query information is identified and inserted. The implicit query information can include fields, aliases, joins, etc. (e.g., that are required by SQL). For example, implicit joins can be identified in the object-based query and inserted into the modified query to make the implicit joins explicit.

As depicted at 540, the query structure is converted into a SQL compatible structure. Specific connector information can be inserted as well. At this point, the resulting converted SQL query can be output from the query conversion engine 310, as depicted at 560. However, in some implementations, the converted SQL query is further enriched with application information, as depicted at 550, before it is output, as depicted at 560. For example, the application information may be needed so that a distributed query engine can select the right connectors to execute the converted SQL query and retrieve the data from the correct application or applications.

The example operations depicted in FIG. 5 can be illustrated using an example object-based query. For example, take the example object-based query depicted in FIG. 4A as the input object-based query depicted at 505. In the first operation (depicted at 510), incompatible keywords are extracted from the object-based query depicted in FIG. 4A. Specifically, the “SUBCLASS NONE” and “INCLUDE INACTIVE” keywords are extracted from the object-based query. The result is the modified object-based query depicted in FIG. 4B. As depicted at 420, the incompatible keywords have been extracted.

Proceeding to the next operation (depicted at 520), metadata is generated for the objects and fields used by the object-based query. Using the example object-based query, FIG. 4C depicts example metadata generated for the “ariba.approvable.core.Approvable” object (entity), as depicted at 430. Specifically, in this example, the metadata maps the “ariba.approvable.core.Approvable” object to the table name “ariba_approvable_core_approvable.” The metadata also maps particular fields, as depicted at 432. Specifically, in this example, metadata maps the object field “UniqueName” to the column “uniquename,” and the object field “ApprovalRequest.AssignedDate” is mapped to the column “approvalrequest_assigneddate.”

Proceeding to the next operation (depicted at 530), implicit query information is identified and inserted. FIG. 4D depicts the example object-based query after an implicit field has been inserted, as depicted at 440, and an implicit join has been identified and inserted as an explicit join, as depicted at 442.

Proceeding to the next operation (depicted at 540), the query structure is converted into a SQL compatible structure. FIG. 4E depicts the example object-based query after it has been converted into a SQL compatible structure. For example, as depicted at 450, entities have been replaced with tables. For example, using the generated metadata depicted in FIG. 4C, the “ariba.approvable.core.Approvable” object has been converted to use the table name “ariba_approvable_core_approvable.” In addition, as depicted in FIG. 4E, the object-based dot notation is no longer present, except for the “Approvable” alias.

In some implementations, the converted SQL query is further processed (e.g., as depicted at 550) so that it can be executed by a distributed query engine. For example, the converted SQL query may not yet include information needed to direct specific elements of the query to specific applications (e.g., to tell the distributed query engine which micro service or legacy application is to serve a particular aspect of the query). In order to provide this information, the converted SQL query is enriched with this application information. The application information can comprise mappings from entities (e.g., via entity name or another type of entity identifier) to locations of applications for servicing the requests (e.g., via URLs or another type of location or endpoint identifier).

In some implementations, the application information for mapping entities to specific applications is needed so that the distributed query engine can select the right connectors to execute the converted SQL query. The connectors are used by the distributed query engine to retrieve the data for the entities participating in the query from the correct application or applications.

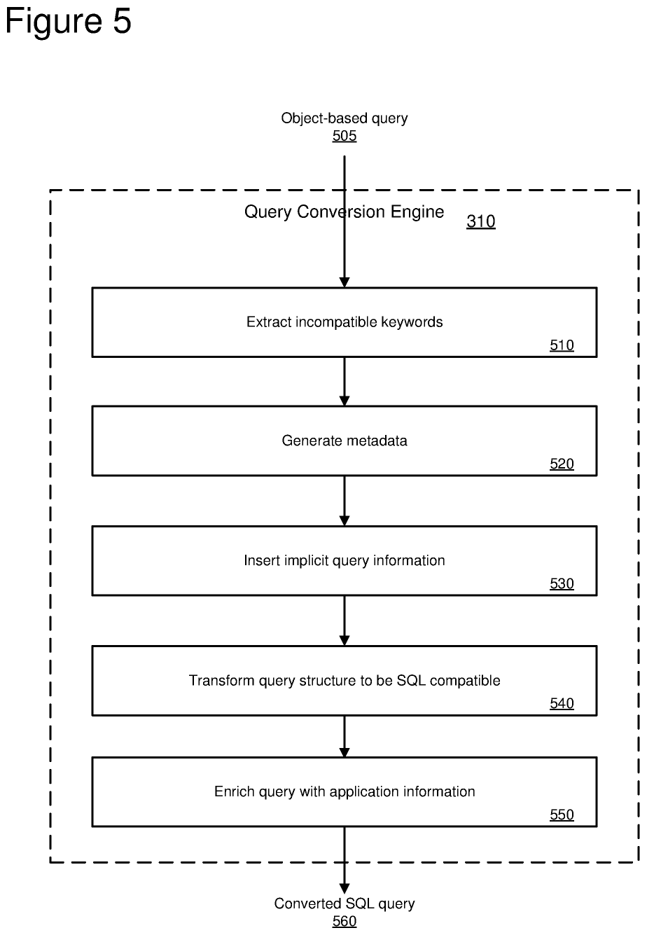

In order to enrich the converted SQL query with the application information, two data structures can be maintained. The first data structure is a mapping table that maps entity names to application identifiers. The second data structure is a mapping table that maps application identifiers to URLs where the applications are located (e.g., where the applications listen for requests). The alias field can be used when creating the converted SQL query to insert application connector prefixes (e.g., used by the distributed query engine to access the application via the URL associated with the alias). In some implementations, these data structures are maintained by a query conversion engine (e.g., by query conversion engine 310) and/or by a distributed query engine (e.g., by distributed query engine 220). For example, the mapping table data structures can be created and updated as described below regarding FIG. 6.

Tables 1 and 2 below are examples of the first and second data structures in an initial configuration where a legacy application is the only application and is responsible for handling all requests.

TABLE 1

| | Application |
|---|---|
| Entity Name | Identifier (AppId) |
| com.ariba.procure.core.Requisition | cfad20e0-6d20-41ac- |
| | bfda-9a2932c62b50 |
| com.ariba.procure.core.Invoice | cfad20e0-6d20-41ac- |
| | bfda-9a2932c62b50 |
| com.ariba.procure.core.InvoiceReconciliation | cfad20e0-6d20-41ac- |
| | bfda-9a2932c62b50 |
| com.ariba.procure.core.Receipt | cfad20e0-6d20-41ac- |
| | bfda-9a2932c62b50 |

TABLE 2

| Application Identifier | Alias | URL |
|---|---|---|
| cfad20e0-6d20-41ac- | buyer | https://s1.ariba.com/Buyer/Main |
| bfda-9a2932c62b50 | | |

Tables 3 and 4 below are examples of the first and second data structures after a new micro service has been created to handle the business function of invoicing. The new micro service will take over responsibility for handling requests for invoice related domain entities (e.g., invoice, invoice reconciliation, etc.). The legacy application will no longer handle the invoice related domain entities.

TABLE 3

| | Application |
|---|---|
| Entity Name | Identifier (AppId) |
| com.ariba.procure.core.Requisition | cfad20e0-6d20-41ac- |
| | bfda-9a2932c62b50 |
| com.ariba.procure.core.Invoice | 4c5eb25e-64c0-45b0- |
| | 819c-22cb8805be93 |
| com.ariba.procure.core.InvoiceReconciliation | 4c5eb25e-64c0-45b0- |
| | 819c-22cb8805be93 |
| com.ariba.procure.core.Receipt | cfad20e0-6d20-41ac- |
| | bfda-9a2932c62b50 |

TABLE 4

| Application Identifier | Alias | URL |
|---|---|---|
| cfad20e0-6d20-41ac- | buyer | https://s1.ariba.com/Buyer/Main |
| bfda-9a2932c62b50 | | |
| 4c5eb25e-64c0-45b0- | invoice | https://mu.ariba.com/invoice.svc |
| 819c-22cb8805be93 | | |

Continuing with the example object-based query, the operation depicted at 550 enriches the converted SQL query with application information, as depicted in FIG. 4F. For example, as depicted at 460, the Approvable and ApprovableType entities will be serviced by the buyer application (e.g., a monolithic legacy application) which is identified by the application connector prefix “buyer.vsapschema” (e.g., which is used by the distributed query engine to retrieve data from the monolithic legacy application), while the PrivateOrgGroup entity will be serviced by the masterdata application (e.g., a micro service application) which is identified by the application connector prefix “masterdata.vsapschema” (e.g., which is used by the distributed query engine to retrieve data from the micro service application).

### Example Query Conversion System

In the technologies described herein, a query conversion system can be provided that converts object-based queries (e.g., queries in a proprietary object-based query language) into SQL queries (e.g., queries that are SQL compatible).

FIG. 6 depicts an example implementation of an object-based query conversion system 600 using some of the elements depicted in FIG. 3. The example implementation of an object-based query conversion system 600 depicts how domain object metadata from legacy applications can be obtained and utilized to support the query conversion process after micro services have been split off from the legacy applications.

As depicted at 610, a first operation involves providing master metadata from the legacy application 250 to the query conversion engine 310 (e.g., as a push operation). The master metadata describes the domain objects (e.g., in an extensible markup language (XML) format or in some other format), including description of domain object fields, names, types, attributes, etc. Based on the received master metadata, the query conversion engine 310 creates entity mapping tables, as depicted in the second operation at 620. When the legacy application 250 is updated, updated metadata can be provided to the query conversion engine 310 as an incremental metadata update (e.g., as a push operation), which is depicted in the third operation at 610. In response, the query conversion engine 310 can update the entity mapping table, as depicted in the fourth operation at 620.

As depicted in the fifth operation at 630, the micro service 230 registers with the query conversion engine 310 (e.g., including obtaining its application identifier (AppId)). As depicted in the sixth operation at 630, the micro service 230 provides its metadata to the query conversion engine 310 (e.g., as a push operation). The metadata provided by the micro service 230 describes the entities that the micro service 230 is responsible for (e.g., after the micro service 230 has been split off from the legacy application 250). In response, the query conversion engine 310 updates the entity mapping tables, as depicted in the seventh operation at 620. The legacy application 250 can also provide incremental master metadata to the query conversion engine 310, as depicted in the eighth operation at 610.

The example implementation of an object-based query conversion system 600 depicts one legacy application and one micro service for ease of illustration. However, the system can support additional legacy applications and/or micro services. For example, as new micro services are added to the system, they can dynamically register themselves (e.g., performing operations such as those depicted at 630) with the query conversion engine 310.

In some implementations, when a new micro service or a new legacy application is added to the system (e.g., is added to the object-based query conversion system 600), the new micro service or new legacy application will automatically publish its metadata to the query conversion engine (e.g., to query conversion engine 310). The following is an example metadata payload that includes the AppId of the new service as well as the entities the new service is responsible for.

{

“appId”: “4c5eb25e-64c0-45b0-819c-22cb8805be93”,
“timestamp”: 1522310195000
“ownedEntities”: [

“com.ariba.procure.core.Invoice”,
“com.ariba.procure.core.InvoiceReconciliation”

]

}

The above example metadata payload can also be sent when services (e.g., micro services, legacy applications, and/or other types of services) are updated (e.g., to update the entities that the service is now responsible for).

### Methods for Converting Object-Based Queries into SQL Queries

In the technologies described herein, methods can be provided for converting object-based queries into converted SQL queries. For example, the SQL queries can be queries that are SQL compatible. In some implementations, a SQL query is SQL compatible if it is compatible with the ANSI SQL standard. In some implementations, a SQL query is SQL compatible if it is ANSI SQL compatible with the addition of application connector prefixes.

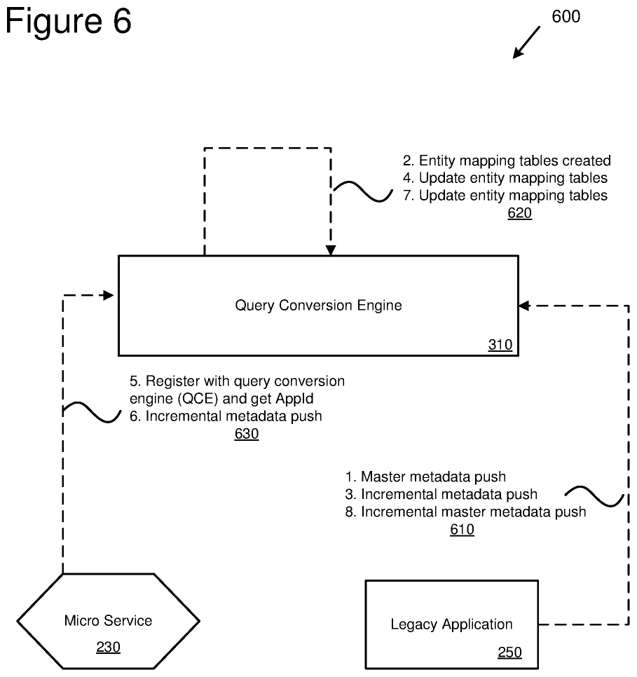

FIG. 7 is a flowchart of an example method 700 for converting object-based query language queries into SQL queries. The example method 700 can be performed by one or more computing devices. For example, the example method 700 can be performed by a query conversion engine, such as query conversion engine 310.

The example method 700 depicts a number of operations that are performed to convert an object-based query into a SQL query (also called a converted SQL query because it has been converted from an object-based query). At 710, incompatible keywords are extracted from an object-based query written in an object-based query language. In some implementations, the object-based query written in the object-based query language references one or more entity hierarchies (e.g., one or more object-oriented hierarchies that are referenced using a dot notation).

At 720, metadata is generated for objects and fields used in the object-based query. For example, the generated metadata maps the objects and fields to their associated database tables and fields.

At 730, implicit query information is inserted into the object-based query. For example, the implicit query information can include implicit fields, aliases, and joins that are made explicit in the converted SQL query.

At 740, a structure of the object-based query is transformed into a SQL compatible structure. Transforming the structure can comprise converting objects to table names (e.g., using the metadata generated at 720).

At 750, the converted SQL query is output. For example, the converted SQL query can be saved and/or executed (e.g., by a query engine). For example, if the converted SQL query has not been enriched with application information, the converted SQL query can be executed by a regular SQL query engine (e.g., which is not a distributed query engine).

In some implementations, the example method 700 further comprises enriching the object-based query with application information for mapping entities to specific applications. In some implementations, the resulting converted SQL query (that has the application information) is ready for execution by a distributed query engine. Execution of the converted SQL query can comprise querying data from at least one micro service and at least one legacy application.

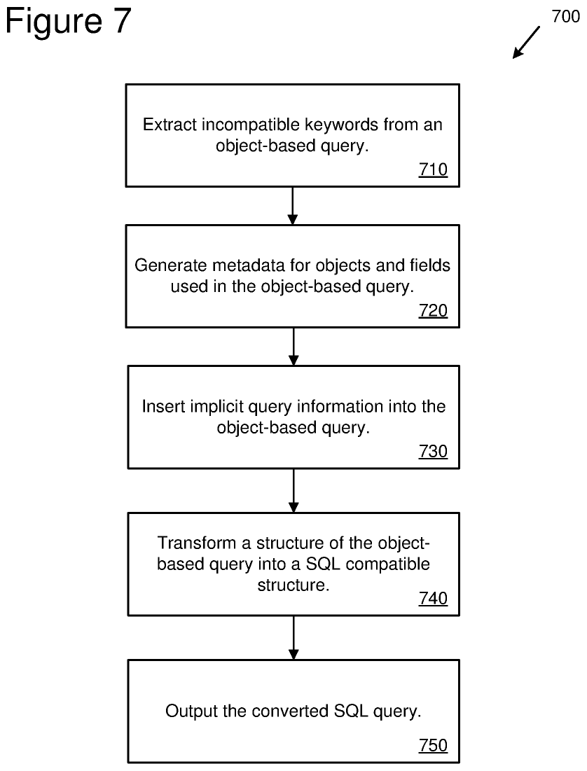

FIG. 8 is a flowchart of an example method 800 for converting object-based query language queries into SQL queries. The example method 800 can be performed by one or more computing devices. For example, the example method 800 can be performed by a query conversion engine, such as query conversion engine 310.

The example method 800 depicts a number of operations that are performed to convert an object-based query into a SQL query (also called a converted SQL query because it has been converted from an object-based query). At 810, an object-based query is received (e.g., via a user interface, a software API, or from another source) for converting to a converted SQL query. The object-based query is written in an object-based query language. For example, the object-based query language can reference on or more entity hierarchies (e.g., using a dot notation).

At 820, incompatible keywords are extracted from the object-based query written in the object-based query language. The incompatible keywords are not SQL compatible.

At 830, metadata is generated for objects and fields used in the object-based query. For example, the generated metadata maps the objects and fields to their associated database tables and fields.

At 840, implicit query information is inserted into the object-based query. For example, the implicit query information can include implicit fields, aliases, and joins that are made explicit in the converted SQL query.

At 850, a structure of the object-based query is transformed into a SQL compatible structure. Transforming the structure can comprise converting objects to table names (e.g., using the metadata generated at 830).

At 860, the object-based query is enriched with application information for mapping entities to specific applications (e.g., for mapping to specific micro services, legacy applications, and/or other types of applications). In some implementations, the application information comprises aliases (e.g., that reference URLs).

At 870, the converted SQL query is output. For example, the converted SQL query can be saved and/or executed (e.g., by a distributed query engine). Execution of the converted SQL query can comprise querying data from at least one micro service and at least one legacy application.

The example method 800 depicts a number of operations that are performed to convert the object-based query into the converted SQL query. In some implementations, all of the operations depicted at 810 through 870 are performed. In other implementations, fewer than all of the operations are performed (e.g., the enrichment depicted at 860 may not be performed in some implementations).

### Computing Systems

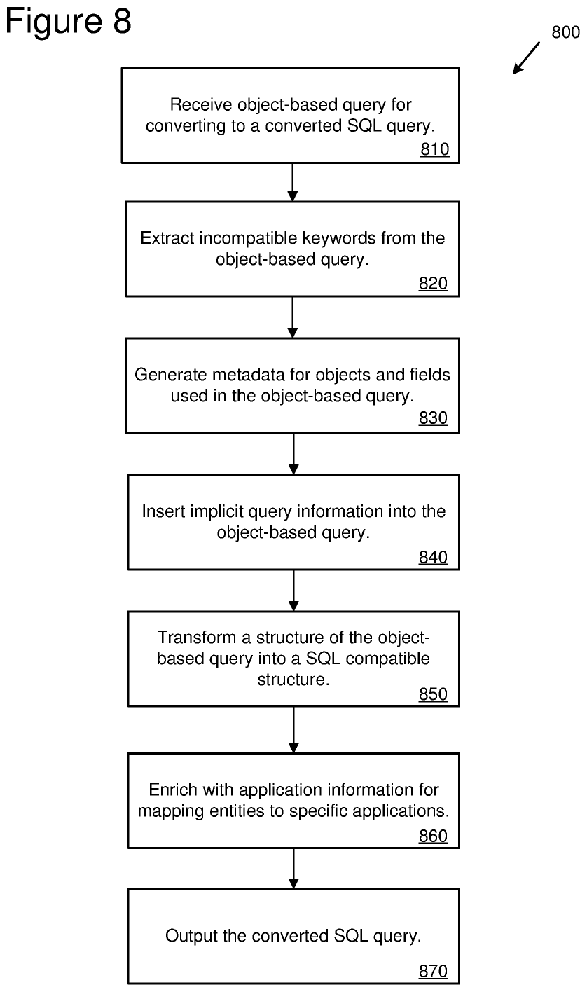

FIG. 9 depicts a generalized example of a suitable computing system 900 in which the described innovations may be implemented. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Cloud Computing Environment

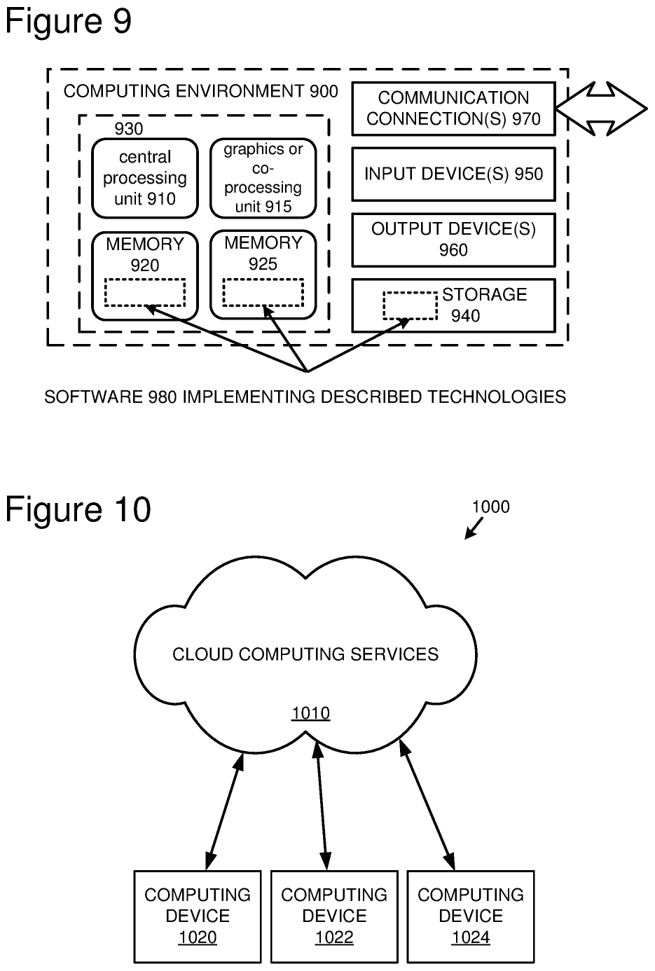

FIG. 10 depicts an example cloud computing environment 1000 in which the described technologies can be implemented. The cloud computing environment 1000 comprises cloud computing services 1010. The cloud computing services 1010 can comprise various types of cloud computing resources, such as computer servers, data storage repositories, database resources, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operators (e.g., data processing, data storage, and the like).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 9, computer-readable storage media include memory 920 and 925, and storage 940. The term computer-readable storage media does not include signals and carrier waves. In addition, the term computer-readable storage media does not include communication connections, such as 970.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method, performed by one or more computing devices, for converting object-based query language queries into structured query language (SQL) queries, the method comprising:
converting an object-based query written in an object-based query language to generate a converted SQL query, comprising:
extracting incompatible keywords from the object-based query, wherein the incompatible keywords are not SQL compatible;
generating metadata for objects and fields used in the object-based query;
inserting implicit query information into the object-based query; and
transforming a structure of the object-based query into a SQL compatible structure, comprising converting objects to table names; and
outputting the converted SQL query that represents the object-based query.

2. The method of claim 1, wherein the object-based query written in the object-based query language references one or more entity hierarchies.

3. The method of claim 1, wherein the object-based query language is a proprietary object-based query language that is not SQL compatible.

4. The method of claim 1, wherein the converted SQL query is American National Standards Institute (ANSI) SQL compatible with the addition of application connector prefixes.

5. The method of claim 1, wherein converting the object-based query to generate the converted SQL query further comprises:
enriching the object-based query with application information for mapping entities to specific applications.

6. The method of claim 1, wherein the generated metadata maps the objects and fields to their associated database tables and fields.

7. The method of claim 1, wherein inserting implicit query information into the object-based query comprises:
identifying implicit joins in the object-based query; and
replacing the implicit joins with explicit SQL joins.

8. The method of claim 1, wherein inserting implicit query information into the object-based query comprises:
identifying implicit fields and implicit aliases in the object-based query; and
inserting the implicit fields and implicit aliases into the object-based query.

9. The method of claim 1, wherein transforming the structure of the object-based query into the SQL compatible structure comprises:
converting the objects to the table names using the generated metadata.

10. The method of claim 1, further comprising:
executing the converted SQL query comprising querying data from at least one micro service and at least one legacy application.

11. One or more computing devices comprising:
processors; and
memory;
the one or more computing devices configured, via computer-executable instructions, to perform operations for converting object-based query language queries into structured query language (SQL) queries, the operations comprising:
receiving an object-based query written in an object-based query language, wherein the object-based query written in the object-based query language references one or more entity hierarchies;
converting the object-based query to generate a converted SQL query, comprising:
extracting incompatible keywords from the object-based query, wherein the incompatible keywords are not SQL compatible;
generating metadata for objects and fields used in the object-based query;
inserting implicit query information into the object-based query;
transforming a structure of the object-based query into a SQL compatible structure, comprising converting objects to table names; and
enriching the object-based query with application information for mapping entities to specific applications; and
outputting the converted SQL query that represents the object-based query.

12. The one or more computing devices of claim 11, wherein the object-based query language is a proprietary object-based query language that is not SQL compatible.

13. The one or more computing devices of claim 11, wherein the converted SQL query is American National Standards Institute (ANSI) SQL compatible with the addition of application connector prefixes.

14. The one or more computing devices of claim 11, wherein the generated metadata maps the objects and fields to their associated database tables and fields.

15. The one or more computing devices of claim 11, wherein inserting implicit query information into the object-based query comprises:
identifying implicit joins in the object-based query; and
replacing the implicit joins with explicit SQL joins.

16. The one or more computing devices of claim 11, the operations further comprising:
executing, via a distributed query engine, the converted SQL query comprising querying data from at least one micro service and at least one legacy application.

17. One or more computer-readable storage media storing computer-executable instructions for execution on one or more computing devices to perform operations for converting object-based query language queries into structured query language (SQL) queries, the operations comprising:
receiving an object-based query written in an object-based query language, wherein the object-based query written in the object-based query language references one or more entity hierarchies;
converting the object-based query to generate a converted SQL query, comprising:
extracting incompatible keywords from the object-based query, wherein the incompatible keywords are not SQL compatible;
generating metadata for objects and fields used in the object-based query;
inserting implicit query information into the object-based query;
transforming a structure of the object-based query into a SQL compatible structure, comprising converting objects to table names; and
enriching the object-based query with application information for mapping entities to specific applications; and
outputting the converted SQL query that represents the object-based query.

18. The one or more computer-readable storage media of claim 17, wherein the generated metadata maps the objects and fields to their associated database tables and fields.

19. The one or more computer-readable storage media of claim 17, wherein inserting implicit query information into the object-based query comprises:
identifying implicit joins in the object-based query; and
replacing the implicit joins with explicit SQL joins.

20. The one or more computer-readable storage media of claim 17, wherein transforming the structure of the object-based query into the SQL compatible structure comprises:
converting the objects to the table names using the generated metadata.
